(19) United States
(12) Patent Application Publication
(10) Pub. No.: US 2012/0253873 A1
(43) Pub. Date: Oct. 4, 2012

(54) ELECTRONIC CLEARINGHOUSE

(75) Inventors: Sean Michael Gerrish, Princeton, NJ (US); Kelly Ryan Suitor, Saginaw, MI (US)

(73) Assignee: BLAST LABS, LLC, Princeton, NJ (US)

(21) Appl. No.: 13/437,536

(22) Filed: Apr. 2, 2012

Related U.S. Application Data
(60) Provisional application No. 61/470,578, filed on Apr. 1, 2011.

(51) Int. Cl. G06Q 10/06

(52) U.S. Cl. 705/7.13

(57) ABSTRACT

Systems and methods for efficiently exchanging goods and services, including sharable goods and services, are provided. Certain aspects relate to electronic auctions and clearinghouses that may be configured to more efficiently distribute resources. A task regarding the performance of services and/or provisioning of goods may be generated without assigning a predefined or pre-specified individual to complete that task. In certain embodiments, any one of a plurality of individuals or a group of individuals (i.e., a business) may bid or accept a task. Pledgers may also provide compensation for the successful completion of a task. Tasks may be updated to reflect an aggregate compensation value.

### CROSS REFERENCE TO RELATED APPLICATIONS

This application claims the benefit of, and priority to, U.S. Provisional Patent No. 61/470,578 filed Apr. 1, 2011, titled “Electronic Clearinghouse,” the contents of which are expressly incorporated herein by reference in their entirety for any and all non-limiting purposes.

### BACKGROUND

For centuries, individuals have bartered goods and services. Certain goods may be exchanged for services, and likewise services may be offered in exchange for goods. In a perfect economic climate, the open exchange of goods and services (either in their pure form or with currency) results in a more efficient allocation of resources. Unfortunately, restrictions, both natural and man-made, increase inefficiencies in the allocating of resources.

Past attempts to increase efficiencies in allocating resources have included using electronic media to remove barriers, such as physical distances, to permit individuals or businesses to sell their goods or services to distant customers. This, however, does not address many problems in the allocation of resources and other shortcomings. Further attempts have included systems that permit a user to propose a task (i.e., a solution to problem) and request resources, usually in the form of monetary funds, to conduct activities to fix that problem. Thus, the workers, themselves, name the market price, and multiple users may contribute to that amount. Unfortunately, these and other attempts have not adequately reduced inefficiencies in the allocation of resources among other drawbacks.

What is needed therefore, are improved systems and methods that address these and other shortcomings of the prior art.

### BRIEF SUMMARY

The present disclosure overcomes problems and limitations of the prior art by providing systems and methods relating to efficient exchange of goods and services. Aspects relate to electronic auctions and clearinghouses that may be configured to more efficiently distribute shared goods or services. In certain embodiments, a worker may be a buyer and provide some service or good in exchange for a plurality of bids. In certain embodiments, pledgers may provide compensation values that may be utilized in the calculation of a total or aggregate compensation value.

Further aspects relate to systems and methods for generating a task regarding the performance of services and/or provisioning of goods. In one embodiment, a predefined or pre-specified individual to complete a task is not assigned upon generating a task. Rather, any one of a plurality of individuals or a group of individuals (i.e., a business) may bid or accept a task.

In accordance with one novel method, a first biddable task may be generated. In one non-limiting example, a task may be created without a minimum bid or price point. For example, an executive of a business entity may create a task and allow others, such as department heads, to provide compensation values. The task may be based on a first set of criteria selected by a first user. In one embodiment, the first set of criteria comprises at least a first completion criterion and a first compensation value. Compensation values may include one or more different currencies or form of resources. Additional compensation may be from multiple users. Some embodiments permit the addition of a second set of criteria from users, however, others do not.

In certain embodiments, a task may be updated to reflect an aggregate compensation value, for example, by summing the multiple compensation values contributed towards the task by different users.

Further aspects relate to the creation of related tasks. For example, a second task may be associated with the first task, such that any one of a plurality of bidders may bid on the first task, however, only a bidder of the first task is permitted to be a bidder on the second task. Yet in other embodiments, additional parties may bid on both tasks.

In certain embodiments, a task may be exclusively assigned to only one bidder, thereby completion of the applicable completion criteria will result in awarding the applicable compensation value to that bidder. In other embodiments, after assigning a bid reception of additional bids from other individuals may be permitted. For example, if it is determined that the assigned bidder either: (a) did not meet the completion criteria; or (b) abandoned the first task, then that task may be assigned to one of the other bidders.

Further embodiments permit associating multiple bidders or workers with a single task, however, only one of them may receive compensation. For example, the first bidder to actually satisfy the completion criteria may be awarded an aggregated compensation value.

Further aspects relate to calculating a deduction amount to be deducted from the first bidder upon a determination that the completion criteria is not met. In one embodiment, the determination is based upon completion criteria not being met by a date in the deadline criteria. In certain embodiments, the deduction amount may be removed upon the user bidding on a task. Yet in other embodiments, the deduction amount may be removed from a user account upon acceptance of a task. The deduction amount may be distributed amongst the one or more users from which a compensation value was received.

Further aspects relate to user-electable tasks that are not provided with an initial minimum compensation value. In one embodiment, a user-electable task based on a first set of criteria selected by a first user may be generated. In one embodiment, a first compensation value may be received from a first pledger. For example, a first pledger may be a department head. Further compensation may be contributed from additional pledgers, such as additional department heads or other individuals in a business entity. Such a system may foster improved allocation of the entity's resources.

In this regard, certain embodiments may permit employees to earn extra merit-based compensation and/or other intangibles, such as vacation days. However, as discussed above, these employees may have to provide a deduction amount to minimize or prevent over committing, fraud or combinations of these and other potential drawbacks. Further embodiments determine pro-rated deduction amounts, for example, that are payable if a user cancels, abandons, and/or does not meet a criteria of the task. Calculation of a pro-rated deduction amount may use one or more formulas.

Of course, the methods and systems of the above-referenced embodiments may also include other additional elements, steps, computer-executable instructions or computer-readable data structures. In this regard, other embodiments are disclosed and claimed herein as well. The details of these and other embodiments of the present invention are set forth in the accompanying drawings and the description below. Other features and advantages of the invention will be apparent from the description and drawings and from the claims.

### BRIEF DESCRIPTION OF THE DRAWINGS

The various aspects of the disclosure are illustrated by way of example and not limited in the accompanying figures in which like reference numerals indicate similar elements and in which:

FIG. 1 shows an exemplary computer network system that may be used to implement various aspects in accordance with the disclosure;

FIG. 2 is a flowchart illustrating one embodiment in accordance with various aspects of the disclosure; and

FIG. 3 is another flowchart illustrating one embodiment in accordance with various aspects of the disclosure.

### DETAILED DESCRIPTION

By way of introduction, the following disclosure provides, inter alia, systems and methods for conducting an electronic auction for the distribution of shared goods or services. Aspects relate to systems and methods that permit a worker to be a buyer and provide some service or good in exchange for the sum total of a plurality of users' bids. This and other non-limiting aspects will be described below.

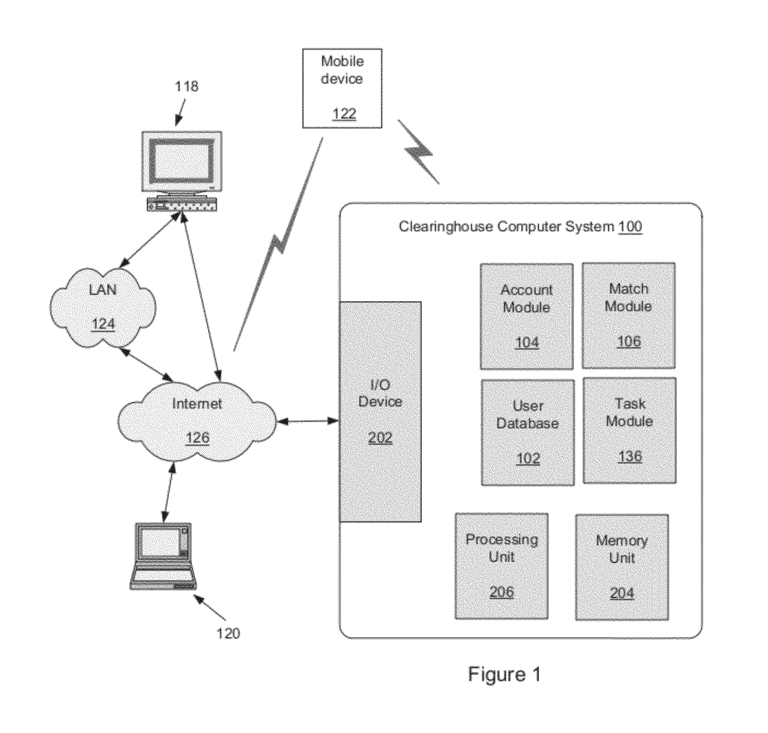

FIG. 1 depicts an illustrative operating environment that may be used to implement various aspects of the disclosure. The operating environment is only one example of a suitable operating environment and is not intended to suggest any limitation as to the scope of use or functionality disclosed herein. Aspects of the disclosure may be implemented with computing devices and networks for exchanging, transmitting communicating, administering, managing and facilitating information including, but not limited to information about users (e.g., workers, pledgers, bidders, etc.), tasks, pledges, accounts (e.g., bank accounts, escrow accounts, etc.) A clearinghouse computer system 100 may receive one or more types of information (including but not limited to any one the aforementioned types), process information, and/or calculate various values (e.g., compensation values, deduction amounts, etc.) in accordance with aspects of the disclosure.

Clearinghouse computer system 100 may be implemented with one or more mainframes, servers, gateways, controllers, desktops or other computers. The computer system 100 may include and/or interact with one or more modules, processors 206, databases, mainframes, desktops, notebooks, tablet PCs, handhelds, personal digital assistants, smartphones, gateways, and/or other components, such as those illustrated in FIG. 1. Moreover, computer system 100 may include one or more processors (e.g., Intel® microprocessor, AMD® microprocessor, risk processor, etc.) and one or more memories 204 (e.g., solid state, DRAM, SRAM, ROM, Flash, non-volatile memory, hard drive, registers, buffers, etc.).

Computer system 100 may comprise user database 102. Database 102 may include information identifying workers, pledgers, bidders, and/or any other users of clearinghouse computer system 100. Such information may include, for example: user names, passwords, historical data and combinations thereof. A user operating an electronic device (e.g., computer devices 118, 120 and 122) interacting with the clearinghouse 100 may be authenticated against user names and passwords stored in the user database 102. Furthermore, an account module 104 may process account information that may be used during task creation, pledging, bidding, matching, payment upon job completion, and/or other actions. The account information may be specific to the particular user (e.g., worker, pledger, bidder, etc.) of an electronic device interacting with the clearinghouse 100.

A match module 106 may assist in matching pledgers, bidders, tasks, and/or workers in accordance with aspects of the disclosure. Match module 106 may be implemented with software that executes one or more algorithms for associating a worker with a task, and for aggregating multiple pledges and/or bids into a single task in accordance with aspects of the disclosure. Numerous different matching processes may also be employed. The match module 106 and task module 136 may be separate and distinct modules or components or may be unitary parts.

Moreover, a task module 136 may be included to store historical information identifying completed tasks and descriptions of prior tasks, workers, and/or pledgers. In particular, a task module 136 may store information identifying or associated with dates/times that a task was accepted, compensation value agreed upon, task completed, and other events. The task module 136 may also comprise a storage device configured to store at least part of the tasks submitted by electronic devices operated by users. A confirmation message may be sent when the match module 106 receives a match for a task and worker. The confirmation message may, in some embodiments, be an e-mail message to a worker and all pledgers, an electronic notification in one of various formats, or any other form of generating a notification.

The network environment shown in FIG. 1 may include computer (i.e., electronic) devices 118, 120 and/or 122. The computer devices 118, 120 and 122 may include one or more processors, or controllers, that control the overall operation of the computer. The computer devices 118, 120 and 122 may also include interface units and drivers for reading and writing data or files through, for example, I/O interface 202. Depending on the type of computer device, a user may interact with the computer with a keyboard, pointing device, microphone, pen device or other input device. For example, the electronic device may be a personal computer, laptop or handheld computer, tablet pc and like computing devices having a graphical user interface (GUI). The electronic device may be a dedicated function device such as personal communications device, a portable or desktop telephone, a personal digital assistant (PDA), remote control device, personal digital media system, tablet, and similar electronic devices.

Computer device 118 is shown directly connected to clearinghouse computer system 100. Computer system 100 and computer device 118 may be connected via a T1 line, a common local area network (LAN) or other mechanism for connecting computer devices. Computer device 118 is coupled to a local area network (LAN) 124. LAN 124 may have one or more of the well-known LAN topologies and may use a variety of different protocols, such as Ethernet. Computer 118 may communicate with other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. Wireless mobile device 122 may also communicate with computer system 100 in a wireless or wired fashion. As used herein, a PDA includes mobile telephones and other wireless devices that communicate with a network via radio waves.

The operations of computer devices and systems shown in FIG. 1 may be controlled by computer-executable instructions stored on computer-readable storage medium. Embodiments also may take the form of electronic hardware, computer software, firmware, including object and/or source code, and/or combinations thereof. Embodiment may be stored on computer-readable media installed on, deployed by, resident on, invoked by and/or used by one or more processors (i.e., processing unit 206), controllers, computers, clients, servers, gateways, networks of computers, and/or any combinations thereof. The computers, servers, gateways, may have one or more controllers configured to execute instructions embodied as computer software. For example, computer device 120 may include computer-executable instructions for receiving information from computer system 100 and displaying to a user. In another example, computer device 118 may include computer-executable instructions for receiving information from computer system 100 and displaying that information to a user. In yet another example, a processor of computer system 100 may be configured to execute computer-executable instructions that cause the system 100 to calculate various values in accordance with the disclosure.

Of course, numerous additional servers, computers, handheld devices, personal digital assistants, telephones and other devices may also be connected to computer system 100. Moreover, one skilled in the art will appreciate that the topology shown in FIG. 1 is merely an example and that the components shown in FIG. 1 may be connected by numerous alternative topologies.

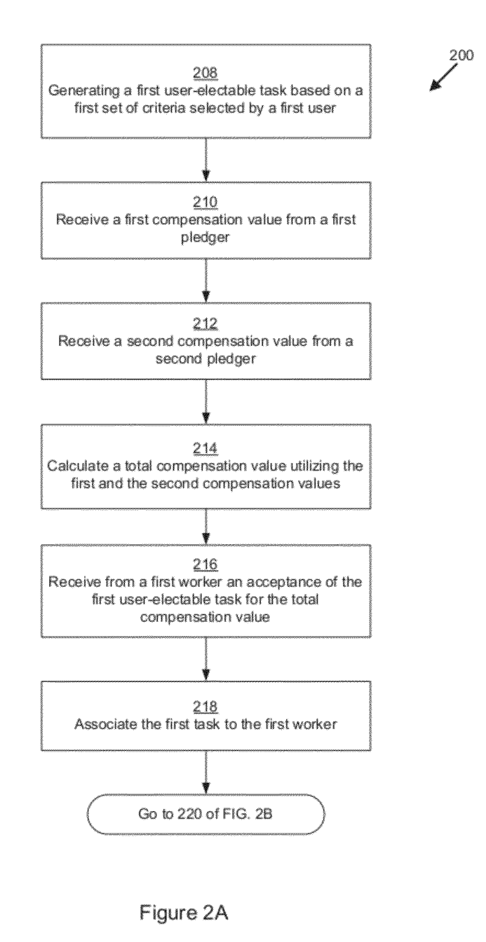

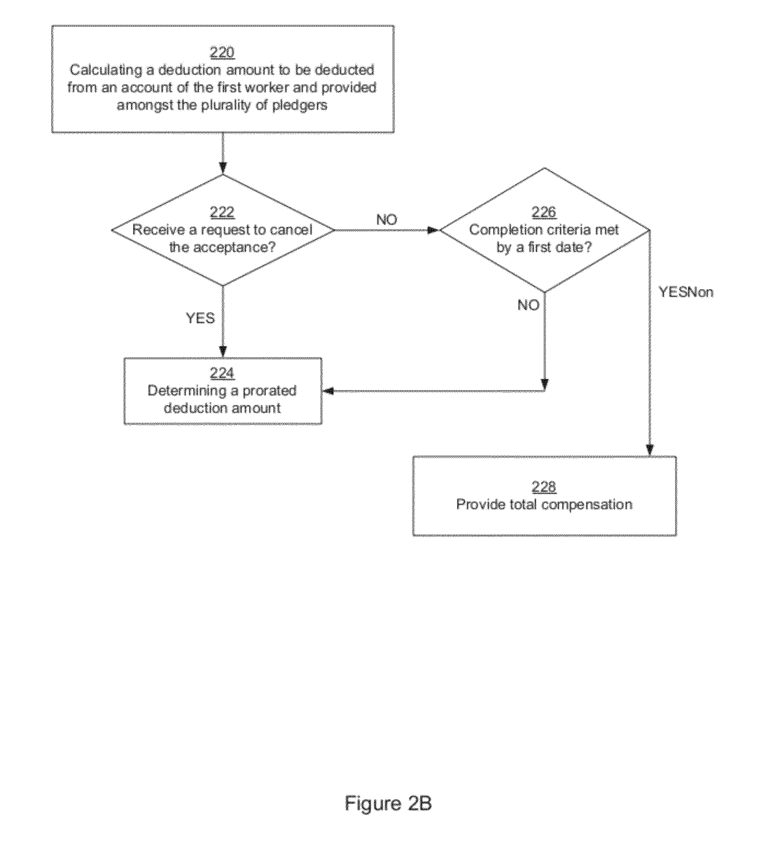

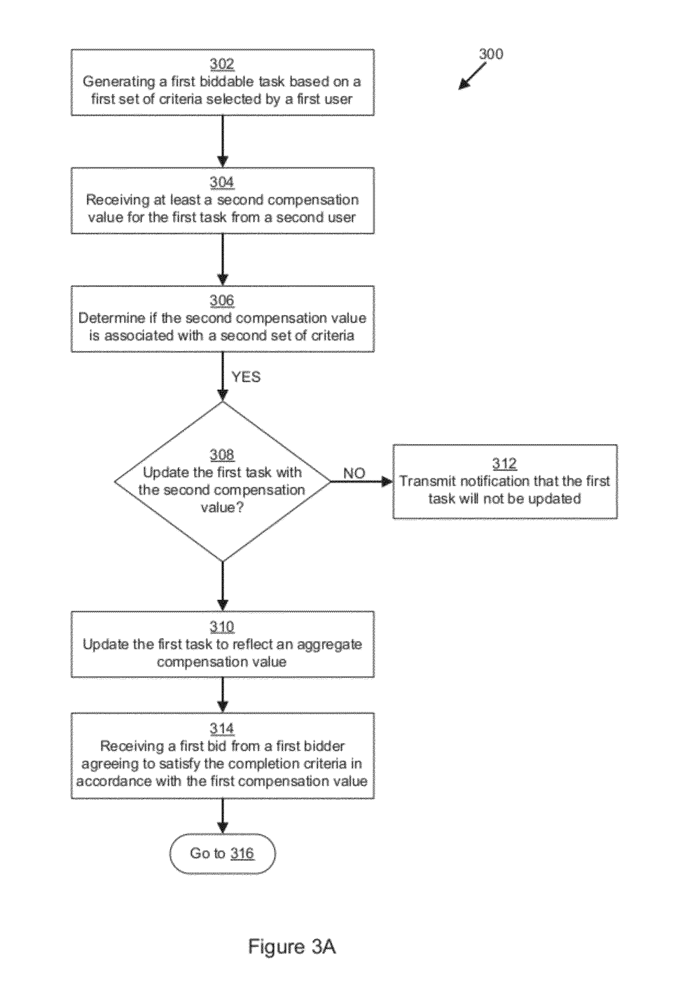

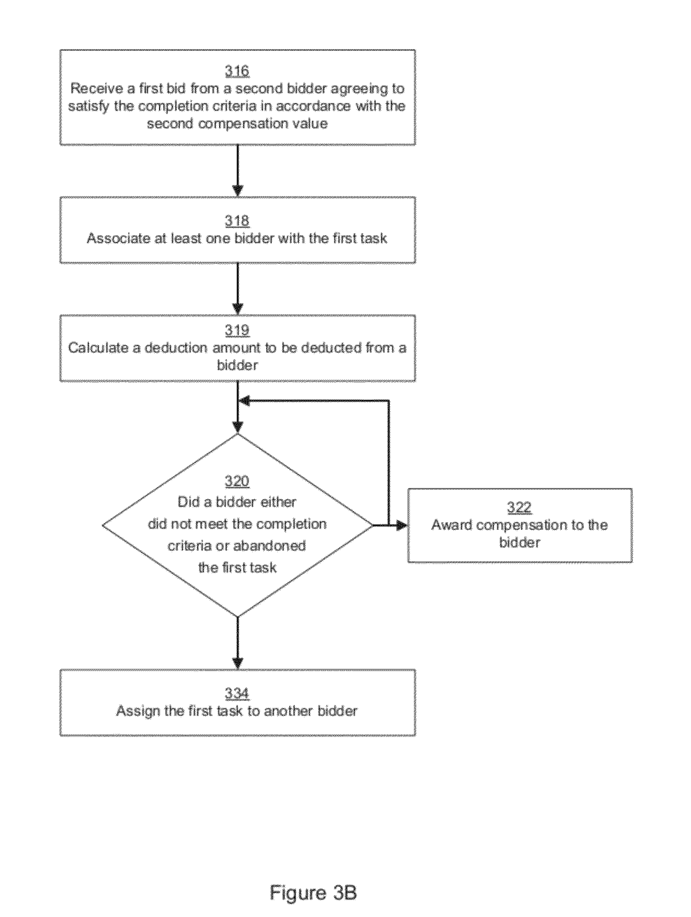

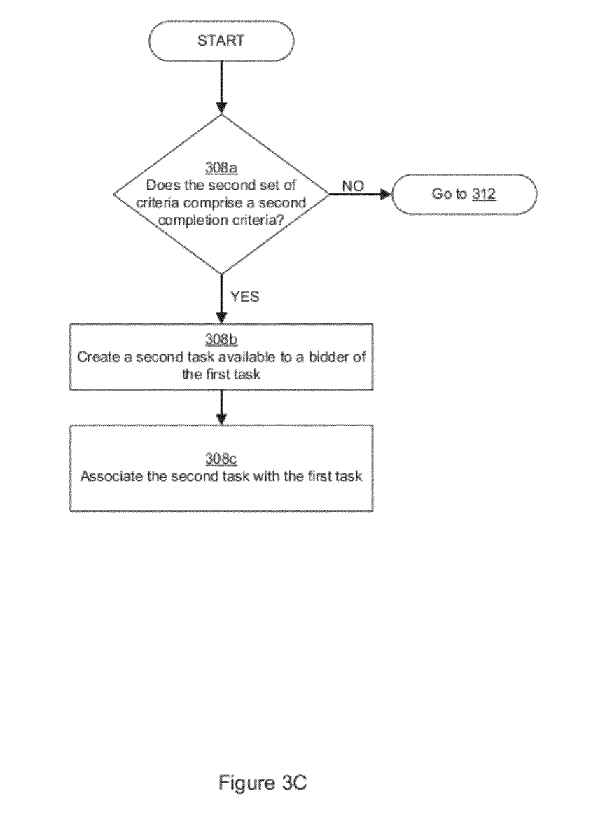

Aspects of the invention relate to systems and methods for administering a task, including the generation of one or more user-electable tasks. Various methods are provided through FIGS. 2A-3C of this disclosure. Those skilled in the art will appreciate that these are merely exemplary methods of various possible implementations. Certain embodiments may comprise additional or fewer processes than those provided within the flowcharts of FIGS. 2A-3C. Further, the order and arrangement of the exemplary methods are merely for illustrative purposes and should not be taken as a limiting feature unless otherwise required by express language of the claimed embodiments or the laws of nature.

Looking first to FIG. 2A, method 200 is illustrated for administering a task, such as through clearinghouse computer system 100. In one embodiment, system 100 may be utilized in the administration of a summed-bid contract. At block 208 of FIG. 2A, clearinghouse computer system 100 may generate a first user-electable task based on a first set of criteria selected by a first user. The task may be “user-electable” as a plurality of individuals may volunteer or otherwise elect to accept or bid on the task. The users may or may not be bidders in accordance with different embodiments. Examples of bidding and non-bidding examples will be provided below. The reader is advised, however, that references to bidders merely refers to an individual that may provide a bid, however, does not exclude, unless otherwise explicitly stated, embodiments in which a “non-bidder” may be utilized. Thus, reference to bidders, pledgers, and/or other individuals is provided to explain some of the many embodiments disclosed in accordance with various aspects of the invention.

The first set of criteria for a task may comprise at least a first completion criterion (e.g., requirements that must be met in order for the task to be considered completed). The completion criteria may include, but are not limited to: dates and times of requested services, including a deadline; specifications or working parameters of a good to be produced or delivered; specific processes of carrying out the services (i.e., must be performed with certain tools or under specific industry guidelines); minimum qualifications: including experience, education, reputation, or feedback (which may be stored on a non-transitory computer-readable medium, such as for example, user-database 102 of FIG. 1).

As a non-limiting example, the generation of the user-electable task may be conducted upon the receipt of an electronic signal representing a user input from an executive (or other employee or representative) of an organization. For example, an organization may permit (and even encourage) the generation of tasks as a mechanism to, among other things: prioritize and organize internal goals, providing incentives, award merit-based bonuses and/or other performance-based compensation. In one embodiment, compensation may be in the form of a credit specific to the organizational structure. In various implementations, employees at an organization can request tools (i.e., create tasks for specific tools) that they believe will benefit the organization, as well as bid on those tools which will make them more productive (bidding and pledging are discussed in more detail below). Other groups and/or individuals in the organization can then accept these tasks and receive compensation in the form of credits if and when they complete the task. This credit may then be tied to performance-based compensation, such as for example, a bonus). Those skilled in the art will readily appreciate that other implementations may benefit a wider range of audiences. In another non-limiting example, tasks may be generated as a tool for prioritizing and focusing science and mathematics academic research, in which bidders bid on open or challenging research problems and workers accept these tasks. In this regard, there is no requirement that the task be established with a minimum bid or compensation amount (however, under certain embodiments, the generation of a task may permit a proposed compensation amount).

At block 210, a first compensation value may be received from a first pledger. In one embodiment, the first compensation value may be received at computer system 100 shown in FIG. 1. The first pledger may be any individual or organization that pledges a resource. The resources are not required to be monetary funds. In this regard, compensation may be tangible or intangible assets. In certain embodiments, compensation may be in the form of credits. In one embodiment, an executive or individual associated with an organization may generate a user-electable task, however, may or may not assign a compensation value to the task. The first pledger may be a department head who pledges a certain portion of his/her budget towards the completion of the task. The departments, themselves may best determine the value of certain tasks and more accurately allocate resources to those tasks.

Depending on the specific implementation, individuals and/or groups that may serve as pledgers may be restricted. For example, individuals may need a certain “clearance” or level to pledge for a specific task. In another embodiment, groups or individuals may be required to be invited to pledge. In yet another embodiment, only a predefined quantity of individuals may be permitted to pledge on a specific task or group of tasks. In certain embodiments, pledgers may receive compensation or another benefit. For example, rewarding those who are early adopters and/or foster the contribution towards the process may increase the amount of tasks being promoted. Further, certain embodiments may provide higher levels of compensation or benefit to pledgers as a function of time or position. For example, a first pledger may receive more compensation or benefit (either as a total amount or as a function relative to his/her contribution) based upon being before a second pledger and so forth. Further, other individuals, such as users who generate tasks may receive compensation or a benefit. In certain embodiments, a compensation or benefit may only be awarded after successful completion of the respective task. This may serve to encourage bidding on certain tasks. One benefit may be a displayable indicia that provides an indication to other users of this pledger's success. For example, a pledger (or other user) who has pledged on 10 tasks and 8 of those were successfully completed may be perceived to have more expertise or experience in a certain field than a second user who pledged 10 tasks, however, only 3 were successfully completed. Thus, the indicia may serve as an indication of a reputation for the user. Those skilled in the art will appreciate that additional users, such as other pledgers, the user who generated the task, workers (such as users who accepted the task) as well as bidders (discussed below in relation to FIGS. 3A-3C) may receive compensation or a benefit for contributing to the generation, bidding, and/or completion of the tasks, in addition to any compensation awarded as a result of completion of a task.

At block 212, another compensation value may be received from one or more additional pledgers, such as at least a second pledger. The compensation values of block 210 and/or 212 may be received at computer system 100 as electronic information through I/O device 202. Those skilled in the art will appreciate that the compensation values may be received from one or more electronic devices, including any one of devices 118, 120, and/or 122. The compensation value may be in a different “currency” or form than other compensation values. For example, a first compensation value may relate to a bonus in the form of monetary resources while a second compensation value may be represented in the form of vacation days or promotion.

At block 214, computer-executable instructions, upon execution by a processor, may calculate a total compensation value using the first and second compensation values. Rules for calculating the total compensation value may be stored as computer-executable instructions on a non-transitory computer-readable medium (i.e., memory unit 204) such that when executed by a processor (i.e., processing unit 206) calculate the total value. The value may be associated with further information. For example, the aggregate value may be associated with the specific task at task module 136, which also may comprise computer-executable instructions storing task-related information on a non-transitory computer-readable medium. The total compensation value may be published alongside the task description (e.g., information about what must be completed for the task to be considered completed, due date, etc.) Block 214 may be conducted in conjunction with or immediately following block 212.

A worker, which may be an employee or representative of the organization, may review the task description and total compensation value and may wish to accept a task. Those skilled in the art will appreciate that there is no requirement that the “worker”, and/or any of the pledgers be employed or otherwise retained by the same organization; however, this may be one implementation. Acceptance of the task may be performed through one or more processes. At block 216, an acceptance of the first user-electable task may be received (for example, such as at computer system 100 from a computing device 120 of a first worker). In certain embodiments, acceptance may entitle the first worker to the total compensation value if the first worker properly completes the task according to the completion criteria associated with that particular task. The completion criteria may have a deadline, such that the task must be completed before a first date to be awarded the full compensation value.

The computer system 100 may associate the first task to the first worker (i.e., at block 218), for example, for tracking purposes. In certain embodiments, associating the first task to first worker essentially assigns the task to a first worker to thereby prevent the assignment of the same task to a second user. In other embodiments, however, multiple workers may be associated with a task. Task information, including the association, may be stored in a task module 136, such as on a non-transitory computer-readable medium.

Certain aspects of this disclosure relate to the use of deductions that may be taken from a bidder, worker, or individual who does not complete a task they have accepted. For example, looking to FIG. 2B, a deduction amount may be calculated (see block 220). In one embodiment, the deduction amount may represent a collection of resources to be deducted from an account (or accounts) of the first worker and provided amongst the plurality of pledgers upon a determination that the completion criteria is not met by a first date. Those skilled in the art will appreciate that an operator of a service, such as an operator of clearinghouse computer system 100 may charge a fee for providing a service, which may or may not be taken from a portion of a deduction amount.

Usage of a deduction amount may serve as a deterrent over committing, incentivize the creation of tasks, and/or prevent or minimize fraud. In one embodiment, a deduction amount may be calculated upon acceptance of the task by the worker. Yet, in other embodiments, it may be calculated at a predefined time and/or upon the occurrence of a specific event.

In certain embodiments, a deduction amount may be posted, such as to be displayable on a graphical user interface. In one embodiment, a deduction amount may be publically displayed, yet in other embodiments only certain individuals, such as bidders, pledgers, workers, and/or combinations thereof may view calculated deduction amounts. By allowing the display or distribution of information regarding calculated deduction amounts, certain embodiments may provide a public notice that a worker has accepted an assignment. In certain embodiments, a bond may be placed on all corresponding bidders' accounts for the amount of their bid (or a portion thereof). In one embodiment, a bidder may be prevented from withdrawing their bids, unless they abandon the task or otherwise are no longer assigned to the task.

Further aspects of this disclosure relate to alteration of the task after acceptances and/or assignments. For example in one embodiment, it may determine whether a request to cancel an acceptance has been received (see block 222 of FIG. 2B). If, before the completion of the completion criteria (i.e., the due date of the task), the first worker requests cancellation of the acceptance (e.g., from block 216) of the first user-selectable task, then the computer system 100 may calculate (e.g. at block 224) a pro-rated deduction amount. In one example, the prorated deduction amount may be determined using Equation 1.

p=(1+b)̂(d/365)(1+F/C)−1; Equation 1:

where F is a fraction of a plurality of user-electable tasks which were fraudulent but not found to be fraudulent, C is a fraction of abandoned tasks within the same plurality of user-electable tasks in which the compensation value was not awarded to a worker, b is an interest rate, and d is the number of days until the task expires. In another example, the prorated deduction amount may be determined using Equation 2.

p=(1+b)̂(d/365)(1+F1/F2)−1 Equation 2:

where F1/F2 is a ratio of a plurality of user-electable tasks in which after providing the total compensation value to a worker have been incorrectly awarded against the cases within the same plurality in which no compensation value was provided to a worker because of a fraudulent finding, b is an interest rate, and d is the number of days until the first date. In another example in accordance with the disclosure, other formulas may be used to calculate the prorated deduction amount. For example, in some embodiments, F and C may be generated from historical statistics of fraud rates to fit a logistic regression, regressed using both word counts in task descriptions and category labels as covariates. Equations 1 and 2 are merely examples of some of the many formulas that may be used in conjunction with determining pro-rated deduction amounts. Further, those skilled in the art will appreciate that a pro-rated deduction amount may be pre-calculated and deducted upon the receipt of the request to cancel the acceptance.

If the first worker successfully completes the task according to the completion criteria (see block 226), the clearinghouse computer system 100 may authorize payment of the total compensation value to the first worker (see block 228). However, if the work is not completed successfully, then computer system 100 may calculate (i.e., at block 224) a deduction amount to be deducted from an account of the first worker and provided amongst the plurality of pledgers. If the deduction amount has already been calculated, it may be distributed according to the terms of the arrangement. In certain embodiments, the determination that a task has been completed per its criteria can be made based on a vote by pledgers, either weighted (such as by their compensation values, time or position of pledge) or not. In certain embodiments, the vote need not be a majority vote. In other embodiments, the vote may be a non-binary vote, such as pledgers and/or other users of the system may provide a score. Further embodiments may allow manual “administrative” intervention to decide whether tasks have been completed per their respective criteria. For example, if pledging users disagree about whether a task has been completed, a computer operator or a designated “expert” (which may encompass a group of users who were not parties to the task) may make a binding determination for the sake of compensation. These and other determinations of completion of tasks and/or compensation may be applied to any embodiment disclosed herein.

It goes from the foregoing that, in accordance with certain implementations, workers may lose more than just credibility from failing to fully complete tasks. For example, if a worker is an employee at an organization whose salary is $100,000, they may elect to complete a task for $5,000, however, be subject to losing 1 vacation day and $500.00 if they fail to meet the completion criteria for the specific task. In this regard, certain aspects of this disclosure not only allow workers to elect to complete certain tasks, but also become bidders and bid on certain tasks or projects. Certain embodiments, therefore, permit workers to become bidders. Allowing bidding on certain tasks by those who will complete (either alone or in conjunction with a group or organization), may allow market forces of supply and demand to assist in the determination of acceptable compensation terms.

Further embodiments may permit a user associated with a task (such as assigned to the task) from having to lose a deduction amount. In this regard, certain events in life, such as an illness or unforeseen circumstance, may prevent a user from successfully completing the task. If the user knows that canceling, abandoning, or otherwise not completing the task will result in a deduction amount being taken, they may attempt to hold on to the task in the off-chance they may have the chance to successfully complete it, albeit maybe against the odds. This may be a unfortunate situation for the user. Further, it increases inefficiencies in the system and may be detrimental to other workers who may be able to complete the task as well as the pledgers, who invested resources towards the completion of the task and the user who generated the task. Therefore, certain embodiments may permit another worker may “buy” the task from the first bidder. The transfer of the task, however, may not require the transfer of compensation in certain embodiments. In some embodiments, the user may receive other benefits, such as a displayable indicia, and/or credits. The transfer of a task may, in certain embodiments, result in the second bidder receiving full compensation for completion of the task. In certain embodiments, the transfer of the task may still result in the original holder of the task paying a “penalty” for abandoning or not completing the task, however, the payment from the worker who may purchase the task from the first user may effectively make this penalty less severe. Such implementations may make the market for tasks more liquid. This transfer may occur in any process disclosed herein after a task has been associated (such as assigned) to a user.

Aspects of this disclosure may be utilized in reporting and/or bidding on fixes to local or regional problems or improvements. Further implementations may include reporting and making bids to remove litter from a highway, using wireless technology such as cellular phones, and/or other tasks relating to the public interest. For example, workers can then accept these location-specific tasks and solve them.

In another non-limiting example, aspects may be utilized as a tool for business-to-business or business to consumer labor exchange, in which businesses are able to place collective bids on goods or services and other entities (businesses or individuals) can accept these tasks. Aspects may also be utilized for influencing public events. For example, a network manager of a television show can create several mutually exclusive tasks. Viewers of the television show can then bid on these tasks; the network could accept one or more of the tasks and implement the one most-highly requested by users.

Further aspects may be utilized as a source for organizing, prioritizing, and managing federal, state, and municipal services, including but not limited to construction, legislation, and tax allocation. For example, a city government can provide residents with an account to report and bid on desired services; such services could then be used to pay city employees or contractors accepting tasks on a freelance or contractor basis.

FIG. 3 is a flowchart of an exemplary process 300 in accordance with one embodiment of the invention. Looking first to FIG. 3A, a first biddable task may be generated at block 302 of exemplary process 300. Generation of the first biddable task may incorporate and/or be similar to the generation of user-electable task described in relation to block 208 of FIG. 2. The first biddable task may be generated at any computer, including for example, clearinghouse computer system 100. In one embodiment, the task is generated based on a first set of criteria selected by a first user. The criteria may be received as electronic information through I/O device 202. Those skilled in the art will appreciate that criteria may be received from one or more disparate electronic devices, including any one of devices 118, 120, and/or 122. In one embodiment, the first set of criteria comprises at least: a first completion criterion and a first compensation value.

Completion criteria and compensation values may be stored on a non-transitory computer-readable medium, such as memory unit 204 of computer system 100. Further, information received at computer system 100, such as through I/O device 202, may be authenticated against account information in the user database 112. For example, user's accessing computer 100 may have to first be authenticated by one or more authentication protocols. Such protocols may be stored as computer-executable instructions on a non-transitory computer-readable medium (i.e., memory unit 204) such that when executed by a processor (i.e., processing unit 206) perform an authentication procedure. Furthermore, account information may be accessed during the generation of the biddable task. Such information may be stored on account module 104, which may comprise a non-transitory computer-readable medium having computer-executable instructions thereon.

At block 304, one or more individuals may provide further compensation. For example, at least a second compensation value for the first task may be received from a second user. As used herein, references to a “second” value or “user” are not intended to limit the disclosure to only two values or users, but are rather provided to distinguish additional values and users from the initial user. Therefore, the exemplary embodiments described throughout this disclosure are not limited by the number of users that may provide compensation towards a single task, nor are users limited to providing only a single compensation value for each task, unless otherwise expressly stated.

Permitting more than one user to contribute a compensation value may allow two or more users, who individually could not afford hiring an individual to perform a task, to collectively contribute to a common goal. Furthermore, clearinghouse computer system 100 provides a common interface to multiple users who may otherwise not be able to contribute towards a common goal. For example, the first bid may be from a business owner seeking a worker to perform specific security-related activities on their property and/or common areas in proximity to the property. For example, a recent elevation in criminal activity may prompt the business owner to consider temporary security measures. Such completion criteria for this task may include, for example: specific dates/times the security activities must occur, the type of equipment (i.e., no firearms may be carried), minimal qualifications, and any other terms of the task. Another business owner may also want to contribute to security activities in the common area. Therefore, after creation of the first task, the second business owner (as well as others) may contribute a compensation value for the security services. Thus, by using their collective contributions, the two business owners, who may never have met before and/or realized they have common interests, may attract a better qualified candidate or outcompete other opportunities available to potential workers.

Further embodiments may implement one or more processes to determine if the second compensation value provided by the second user (or any value submitted by anyone after the generation of the task) is associated with a first set of criteria from the first user or a second set of criteria from the second user (i.e., see block 306). For example, the second user may add completion criteria for a bidder to perform for the additional compensation. Using the example above, the second bidder may request that the worker who wins the bid further perform security for extra time and/or over a different property. Therefore, in certain implementations, block 308 may be performed upon determining that the second compensation value is provided in conjunction with additional criteria. In certain embodiments, there may not be an option to associate additional criteria; therefore, this process is entirely optional.

Block 308 may comprise determining whether to update the first task with the second compensation value. In one embodiment, the presence of any additional completion criteria may prevent the application of the second compensation value to the task (see, e.g. block 312). In one such embodiment, a second task may be created or at least an option to create a second task may be provided. These features may be a system rule, yet in other embodiments, such rules may be at the discretion of a user that generated the task at issue, and/or other criteria (which may also be at the discretion of the current bidders). For example, in one embodiment, the user that generated the task may be notified by electronic means of additional completion criteria. In certain embodiments, other users, such as pledgers, bidders, and/or other parties may be notified. The user that generated the task (and/or other parties) may elect whether to allow the additional criteria to be associated with the first task. In certain embodiments, the second user may provide compensation to the first user who created the task for allowing the second criteria to be associated with the task. In one embodiment, the first user may provide an asking price or otherwise request an amount for the second user to be associated with his task. This may allow both users to mutually benefit while at the same time ensuring the first user does not have to contribute too much for services he will not benefit from.

Turning briefly to FIG. 3C, a flowchart of an illustrative method that may be performed as part of one or more exemplary processes for determining whether to update the first task with the second compensation value is provided. Specifically, FIG. 3C provides an exemplary process that, when executed, may not update the first task with the second compensation value, but rather may, in certain embodiments, initiate the creation of a second task. Sub-block 308a may be initiated upon a determination that a bid following the first bid comprises additional completion criteria. In one embodiment, if the second set of criteria encompasses the first completion criteria, such that the requirement of the first task must be fulfilled as part of completing the new completion criteria, then sub-block 308b may be implemented. Alternatively, in one embodiment, if its determined that the second completion criteria omits essential material of the first task, notification may be provided that the first task will not be updated with the second compensation value (i.e., block 312). As would be appreciated by those skilled in the art, in certain implementations, users may dictate which completion criteria is essential and otherwise required and which completion criteria, if any, is subject to modification by bidders looking to compete.

Instead of associating the second compensation value with the first task, sub-block 308b may be implemented to create a second task. Sub-block 308c may also be implemented to flag or otherwise mark the second task as being available to a bidder of the first task. In one embodiment, only bidders who have a bid on the first task may be eligible to provide a bid on the second task. For example, Sub-block 308c may be implemented to associate to first task with the first task, such that any one of a plurality of bidders may bid on the first task, however, only a bidder of the first task is permitted to be a bidder on the second task. In another embodiment, rules (which may be provided as computer-executable instructions that when executed by a processor) may create a second task that is distinct from the first task such that a bidder that did not bid on the first task may bid on the second task.

Therefore, in certain embodiments, the first task will remain associated with only the first compensation value and the second task may be associated with an aggregate value representing that excludes the first compensation value. In other embodiments, however, the second task may be associated with the first and the second compensation values. In this regard, the above example is does not preclude implementations that associate the second compensation value with the first task.

In one embodiment, if the second compensation value is associated with the first bid, block 310 may be utilized to update the first task to reflect an aggregate compensation value. In one embodiment, the first and the second compensation values may be summed together. As discussed above, there is no requirement that either value be of the same “currency” or form. Rules for calculating an aggregate compensation value may be stored as computer-executable instructions on a non-transitory computer-readable medium (i.e., memory unit 204) such that when executed by a processor (i.e., processing unit 206) calculate the aggregate value. The value may be associated with further information. For example, the aggregate value may be associated with the specific task at task module 136, which also may comprise computer-executable instructions storing task-related information on a non-transitory computer-readable medium.

In certain embodiments, compensation according to the compensation value of the second task may be configured to not be distributed until the reception of an electronic signal indicative that the first task has been completed. In one embodiment, processing unit 206 may process computer-executable instructions on a non-transitory computer-readable medium that when executed review the status of the tasks, such as on task module 136.

Block 314 may be implemented to receive a first bid from a first bidder. In one embodiment, the bid may serve as an agreement to satisfy the completion criteria in accordance with the first compensation value (or compensation values currently associated with the task). Block 314 or any other process of receiving a bid may be similar or identical to block 216 of FIG. 2. Further bids may be received from multiple bidders. For example, after receiving an initial bid from the bird bidder, a first bid may be received from a second bidder agreeing to satisfy the completion criteria in accordance with the second compensation value (see block 316 of FIG. 3B). Again, there is no requirement that the compensation values be of the same “currency” or form.

Block 318 of FIG. 3B may associate at least one bidder with the first task. In one embodiment, the first bidder may be associated with the first task according to the first completion criteria and the first compensation value (or aggregate compensation value). In one embodiment, the association of the first bid may be an assignment. For example, the first task may be assigned only to the bidder. In one such implementation, upon the passing of a predetermined period of time or upon the occurrence of an event, the highest bidder may be assigned the task. In certain embodiments, the user who generated the task may determine which bidder the task is assigned to. For example, this may be advantageous for tasks in which at least two bids are provided in different currencies or forms. Thus, a user may select the compensation that best suits them. An assignment of the task may ensure that completion of the applicable completion criteria will result in awarding the applicable compensation value to the assigned bidder.

In another embodiment, multiple bidders may be associated with the task. For example, each bidder may be associated with the task and the first bidder or group of bidders that completes the completion criteria for the task is awarded the aggregate compensation value. Bidders may or may not see other bidders that have bid on the same tasks depending on the various embodiments.

At block 319, a deduction amount may be determined. Block 319 and/or any other process for determining a deduction amount may be similar or identical to block 224 of FIG. 2. In this regard, the disclosure of block 224 is incorporated for any and all purposes for possible implementation in any embodiments disclosed herein, including the use of Equations 1 and/or 2. In one embodiment, the deduction amount may be configured to be provided amongst the one or more users from which a compensation value was received upon a determination that the completion criteria is not met by a first date in the applicable deadline criteria.

In one embodiment, even if a user (i.e., a first bidder) is exclusively assigned a task, a second bidder may be associated with the first task according to the second compensation value and any applicable second completion criteria. In certain embodiments, it may be determined whether another bidder (i.e., the first bidder) either: (a) did not meet the completion criteria; and/or (b) abandoned the first task (see, e.g., block 320), such as for example, canceled the task or failed to meet milestones. Based upon the determination, block 324 may be implemented to assign the task to another bidder (i.e., the second bidder). The deduction amount may also be provided to one or more users that provided a compensation value associated with the task (such as being part of the aggregated compensation value). If a bidder assigned or associated with a task, however, does not abandon the task and completes the completion criteria, then block 322 may be implemented to award the aggregated compensation value.

In further embodiments, a bidder/worker may be awarded the aggregated compensation value before full completion of a task. For example, in one embodiment, a determination may be made (or information indicative of a determination may be received) that is indicative that a worker is deemed likely to complete a given task. In certain embodiments, a bidder/worker may be deemed likely to complete a task if s/he has successfully completed many tasks before and/or has earned a reputation for successfully completing tasks. This reputation may be measured by the total number of successfully completed tasks, the fraction of accepted tasks which were successfully completed, the sum of aggregate compensation values associated with completed tasks, the fraction of completed tasks successfully completed weighted by the aggregate compensation value of these tasks, and a combination thereof among other considerations. This reputation might also be measured by a payment the bidder/worker has made to, or a bond s/he has placed with, the clearinghouse. A worker may also be deemed likely to complete a task by a human administrator who recognizes that the worker/bidder has a good brand reputation which is associated with credible meeting of financial and contract obligations. This reputation might also be based upon, at least in part, a third party rating, such as a possessing a high credit rating, such as a high FICO® score.

In further embodiments, a third compensation value may be received after associating or assigning at least one bidder to the first task. In one embodiment, the aggregate compensation value may be recalculated by combining the first, second and third compensation values. The task may then be updated to reflect the recalculated aggregate compensation value.

Further aspects relate to graphical user interfaces that may be implemented to provide one or more of the features discussed herein. One or more devices, such as for example, computer system 100 may comprise a non-transitory computer-readable medium with computer-executable instructions, that when executed by a processor provide a user interface for transmitting and receiving information as part of one or more of the features described above, including receiving electronic information representing a user input from creating tasks, pledging, bidding, cancelling bids, and combinations thereof. Examples of possible capabilities that may be included in a user interface, include but are not limited to: a) a text search engine configurable to index the text of tasks' descriptions, specifications, and/or category labels; b) a list of recommended tasks, where recommendations may be made based on tasks the user has visited while using the service and/or tasks related to those that the user has bid on; c) a categorical list of tasks, where users may browse tasks using a hierarchy of categories or location names; d) a list of featured tasks, where featured tasks may be selected as the top tasks based on based on (1) number of page views during a time frame, such as the last hour, day, or week, (2) total bid value, or (3) how recently the task was added or bid on; e) a wireless location-service, such that a user's location may be compared with a plurality of tasks and configurable to alert a user of tasks within a specified or defined geographic range. Those skilled in the art with the benefit of this disclosure will appreciate that other features may be implemented into various embodiments without departing from the scope of this disclosure.

Further embodiments relate to storing and/or distribution of the results of a task to the pledgers or other users. For example, in one embodiment, a worker may have access rights or otherwise have the ability to electronically submit a work product to one or more users, such as pledgers. For example, if a worker's work product is a research paper, the worker may transmit the work product to a non-transitory computer-readable medium, such as memory unit 204 of computer system 100 shown in FIG. 1. Computer-executable instructions, when executed by a processor, such as processing unit 206, may execute methods that permit other users, such as bidders to bid on a task and/or users who generated the task to access it.

Further embodiments may provide for a time delay after posting of a task in which comments may be posted but no workers may bid and/or accept it during the delay. Further embodiments may categorize users, including for example, workers. Categorization may be by any distinguishing factor, including for example: location, education reputation, past abandonment rates, credits, reviews, or combinations thereof. In one embodiment, users may be stratified by the distinguishing factor, for example, workers may be stratified by historic abandonment rates, such as >99.9% completion, >99% completion, >98% completion, >95% completion, >90% completion. Under certain implementations, users may set criteria for excluding potential workers accepting tasks based upon one or more criteria.

In further embodiments, the invention may recognize one or more various forms of currency, including virtual and/or physical forms, and may in certain implementations restrict award of the aggregate compensation to specific bidders/workers based on one or more forms of currency. For example, a bidder/worker associated with brand or entity “X” may provide $100 of brand-X-currency to a set of users. Users may then create and/or contribute compensation toward one or more tasks with a first currency (such as U.S. dollars), a second currency (such as brand-X-currency) or both. The worker/bidder associated with brand X may then accept and complete these tasks. However, in certain embodiments, a worker/bidder without brand X cannot be compensated with brand-X-currency. It will be apparent to those skilled in the art that this can be accomplished by forbidding a user from contributing brand-X-currency to certain tasks, withholding this amount from compensation to a non-brand-X worker/bidder, and by forbidding a worker which is not brand-X from receiving compensation, and in other ways.

In one embodiment, a pledger may pledge toward a task, and his compensation value will be deducted from his account. The pledger may then change his mind about the pledge before it has been accepted by a worker, and he will receive credit in his account for the amount of the pledge (and this amount will be subtracted from the total compensation value), but the pledger cannot cancel his pledge after the task has been accepted. In still another embodiment, the pledger can cancel his task after a worker has accepted the task, but the pledger may not receive all of his initial pledge.

The embodiments have been described herein with reference to specific exemplary embodiments thereof. It will be apparent to those skilled in the art, that a person, after having reviewed the entirety disclosed herein, may conceive of changes or other embodiments or variations, which utilize the principles of this disclosure without departing from the broader spirit and scope of the disclosure as set forth in the appended claims. All are considered within the sphere, spirit, and scope of the disclosure. Those skilled in the art will appreciate that aspects of the invention may be used in other industries.

We claim:

1. A computer-implemented method comprising:
generating a first user-electable task based on a first set of criteria selected by a first user, wherein the first set of criteria comprises at least a first completion criterion;
receiving a first compensation value from a first pledger;
receiving a second compensation value from a second pledger;
calculating a total compensation value utilizing the first and the second compensation values;
receiving from a first worker an acceptance of the first user-electable task for the total compensation value;
associating the first task to the first worker; and
after acceptance, calculating a deduction amount to be deducted from an account of the first worker and provided amongst the plurality of pledgers upon a determination that the completion criteria is not met.

2. The method of claim 1, wherein the deduction amount is subtracted from an account of the first worker upon acceptance.

3. The method of claim 1, wherein the generated first task is devoid of a compensation value.

4. The method of claim 3, further comprising:
after acceptance but before the first date, receiving an indication from the first worker requesting cancellation of the acceptance of the first user-selectable task; and
determining a prorated deduction amount.

5. The method of claim 1, wherein the second compensation value is subtracted from an account of the second user upon an electronic signal indicative that the second user has made a pledge.

6. The method of claim 5, further comprising:
before acceptance, receiving an indication from the second user requesting cancellation of the pledge; and
adding the second compensation value to an account of the second user.

7. A computer-implemented method comprising:
generating a first user-electable task based on a first set of criteria selected by a first user, wherein the first set of criteria comprises at least a first completion criterion;
receiving a first compensation value from a first pledger;
receiving a second compensation value from a second pledger;
calculating a total compensation value utilizing the first and the second compensation values;
receiving from a first worker an acceptance of the first user-electable task for the total compensation value; and
associating the first task to the first worker.

8. A computer-implemented method comprising:
generating a first biddable task based on a first set of criteria selected by a first user, wherein the first set of criteria comprises at least: a first completion criterion and a first compensation value;
receiving at least a second compensation value for the first task from a second user;
if the second compensation value is associated with a second set of criteria from the second user, determining whether to update the first task with the second compensation value; and
updating the first task to reflect an aggregate compensation value by summing the first and the second compensation values.

9. The method of claim 8, wherein the first set of criteria comprises a deadline criterion.

10. The method of claim 8, further comprising:
determining whether the second set of criteria comprises a second completion criteria; and
wherein if the second completion criteria encompasses the first completion criteria, then creating a second task available to a bidder of the first task.

11. The method of claim 10, wherein the second task is associated with the first task, such that any one of a plurality of bidders may bid on the first task, however, only a bidder of the first task is permitted to be a bidder on the second task.

12. The method of claim 10, wherein the second task is distinct from the first task such that a bidder that did not bid on the first task may bid on the second task.

13. The method of claim 12, wherein compensation according to the compensation value of the second task is configured to not be distributed until the reception of an electronic signal indicative that the first task has been completed.

14. The method of claim 8, further comprising:
receiving a first bid from a first bidder agreeing to satisfy the completion criteria in accordance with the first compensation value;
receiving a first bid from a second bidder agreeing to satisfy the completion criteria in accordance with the second compensation value; and
associating the first bidder and the second bidder with the first task.

15. The method of claim 14, wherein the first bidder is associated with the first task according to the first completion criteria and the first compensation value.

16. The method of claim 15, wherein the second bidder is associated with the first task according to the second compensation value and any applicable second completion criteria.

17. The method of claim 8, further comprising:
receiving a first bid from a first bidder;
assigning the first task only to the bidder, thereby completion of the applicable completion criteria will result in awarding the applicable compensation value to the first bidder.

18. The method of claim 17, further comprising:
after assigning the first task to the first bidder, permitting the reception of a second bid from a second bidder;
determining that the first bidder either:
(a) did not meet the completion criteria; or
(b) abandoned the first task; and
based upon the determination, assigning the first task to the second bidder.

19. The method of claim 12, further comprising:
receiving a second bid from a first bidder that satisfies the second compensation criterion;
associating the second bidder with the first task, such that both the first bidder and the second bidder are each associated with the first task; and
upon receiving verification of successful completion of the task, awarding compensation set forth in the second compensation criteria to either the first or the second bidder, but not both of the bidders.

20. The method of claim 8, further comprising:
receiving a first task from a first bidder;
assigning the first task to at least the first bidder;
after assigning the first task to at least the first bidder, receiving a third compensation value;
recalculating the aggregate compensation value by combining the first, second and third compensation values; and
updating the first task to be associated with the recalculated aggregate compensation value.

21. The method of claim 9, further comprising:
after reception of a bid from a bidder, calculating a deduction amount to be deducted from the first bidder and provided amongst the one or more users from which a compensation value was received upon a determination that the completion criteria is not met by a first date in the deadline criteria.
